(19) United States
(12) Patent Application Publication
(10) Pub. No.: US 2017/0154517 A1
(43) Pub. Date: Jun. 1, 2017

(54) AIR QUALITY ALERT SYSTEM AND METHOD

(71) Applicant: KONINKLIJKE PHILIPS N.V., EINDHOVEN (NL)

(72) Inventors: DZMITRY VIKTOROVICH ALIAKSEYEU, EINDHOVEN (NL); JOHANNES HENRICUS MARIA KORST, EINDHOVEN (NL); JAN MARTIJN KRANS, EINDHOVEN (NL); MAURO BARBIERI ABN AMRO, EINDHOVEN (NL); JONATHAN DAVID MASON, EINDHOVEN (NL); SERVERIUS PETRUS PAULUS PRONK, EINDHOVEN (NL); JOHAN PARTOMO DJAJADININGRAT, EINDHOVEN (NL); KORAY KARAKAYA, EINDHOVEN (NL); FRANCISCUS JACOBUS VOSSEN, EINDHOVEN (NL); SEYOUNG KIM, EINDHOVEN (NL); JOHAN MARRA, EINDHOVEN (NL); PIETER JOSEPH MATHIAS CUSTERS, EINDHOVEN (NL)

(73) Assignee: Koninklijke Philips N.V.

(21) Appl. No.: 15/323,537

(22) PCT Filed: Jul. 2, 2015
(86) PCT No.: PCT/EP2015/065048

§ 371 Date: Jan. 3, 2017

(30) Foreign Application Priority Data
Jul. 4, 2014 (EP) 14175718.7

(51) Int. Cl. G08B 21/12; H04W 4/02

(52) U.S. Cl. CPC G08B 21/12; H04W 4/02

(57) ABSTRACT

An air quality alert system provides a signal which indicates whether or not a door or window should be (fully or partially) opened or closed. The system takes account of the air quality in a first area (e.g. outdoors) as well as the proximity of the user to a door or window so that information is only provided when the user is situated at the door or window. This avoids overloading the user with unwanted information.

### FIELD OF THE INVENTION

The invention relates to an air quality alert system, for example advising a user when the outdoor air quality has reached a level that action should be taken, such as closing doors or windows.

### BACKGROUND OF THE INVENTION

Many large cities suffer from air pollution and in countries like China air pollution is becoming the biggest health threat. For example, measurements in January 2013 showed levels of air pollution, as measured by the density of particulate matter smaller than 2.5 micrometers in size, which were higher than the maximum 755 μg per cubic meter level which can be measured by the US Embassy's equipment.

It is therefore no surprise that many Chinese families are using air purifiers at home and in their cars.

Despite the high level of pollution, people still would like to open windows regularly, because outside air is considered to be always fresher than inside air.

Air cleaning devices may be used to clean the air in the home after coming in through the window, but there is no mechanism for informing the user about the air quality outside, for example whether it is better or worse than inside. Global city information may be available giving air quality indications, but a user may not want to be troubled by having to access and then interpret this information.

EP1365371A1 describes a method and system for preventing person entering dangerous area, by hindering opening of a door based on sensing. However, the described method/system only monitor if the area the user is entering is dangerous or not, despite the situation of the area that the user is currently in.

### SUMMARY OF THE INVENTION

The invention is defined by the claims.

According to an aspect of the invention, there is provided a system, comprising:

an input for receiving a first air quality indication for a first area;

a proximity sensing arrangement for determining if a user is in the proximity of a door or window between the first area and a second area;

an output for providing a recommendation for a status of the door or window; and

a processor,

wherein the processor is adapted to process the first air quality indication and a signal from the proximity sensing arrangement, and to control the output accordingly.

This system is able to provide advice to a user about whether or not to open or close a door or window, for example depending on either the absolute air quality outside, as represented by the first air quality indication, which is a signal giving information about the air quality in the first area. The output signal may simply indicate whether a door or window should be open or closed, or it may for example indicate how widely a window or door should be opened. Thus, an instruction can be given to open a window wider, or to partially close a window. By using a proximity sensor, the user can only be provided with the required information when it is needed, for example when the user is contemplating opening the door or window to improve ventilation. In this way, the user is not annoyed with unnecessary information, and the system can save power. The use of a proximity sensor means that the user does not need to specifically activate the system in order to be presented with the required advisory information.

The first area may be outdoors and the second area may be indoors (the term “indoors” is intended for example to include being inside a vehicle). However, the system may also provide recommendations in respect of doors between internal rooms, for example for controlling the flow of air throughout a space.

The output may be any device able to provide a signal to the user. It may for example be an LED output, a display device or an audio device which has a fixed location near the door or window. In this case, the output device is part of the system. Alternatively, it may be a device carried by the user, such as a cellphone. In this case, the system controls a remote output device which may not form part of the system itself in the sense that the output device is already in place before the system is installed.

The proximity sensing may be remote (for example using infrared sensing) or it may be based on touch, for example the user touching the door or window handle. Alternatively, it may be based on a distance beacon or wireless communication with a device carried by the user, for example using a smart phone device.

The output may be provided to an output device carried by the user, and only activated when they are near the window or door, or it may be fixed at the door or window. The air quality indication for the first area can be obtained by a sensor of the system but it may also be obtained from a remote third party source of information.

The system may further comprise an input for receiving an indication of a second air quality for a second area, which may comprise an indoor area. This enables advice to be provided based on the difference between indoor and outdoor air quality.

The system may comprise a first air quality sensor for measuring and providing the first air quality indication and a second air quality sensor for measuring and providing the second air quality indication. Thus, the system may include the required sensors, although optionally also receiving information from other sources.

The processor may be adapted to control the output device based on a difference between the first and second air quality indications. This enables the instruction to be based on a relative air quality, for example the air quality outside compared to the prevailing air quality inside. This enables determination of whether opening the door or window will improve or worsen the indoor air quality.

The system may further comprise an input for receiving at least one of the following parameters:

the weather conditions;

the noise level;

the light level;

the status of other windows or doors leading to the second area;

air quality indications from other air quality sensors relating to the first area provided at the building at which the system is mounted;

air quality indications from other outdoor air quality sensors relating to the first area and not provided at the building at which the system is mounted;

air quality indications from indoor air quality sensors provided at the building at which the system is mounted;

publicly broadcast air quality warning information;

status information from climate control devices.

The weather, noise and lighting information enables a judgment to be made as to whether the door or window should be closed for reasons other than the air quality. In certain areas, the light level may influence the decision based on the fact that insects may be attracted.

The status of doors and windows enables the overall ventilation to be considered rather than just the ventilation provided by the door or window from which proximity is detected.

The air quality indications from other sensors (of the same building or of other buildings in the neighborhood) enable dynamic changes in the local environment to be monitored, for example. Depending on the range and number of other sensors, it may be possible to make predictions about how long the window or door should be left open, for example.

Publicly broadcast air quality warning information may for example relate to high pollen count, or pollution events, for example from a chemical plant or a forest fire.

The system may comprise a wireless data transfer system for wirelessly transmitting data to a remote terminal. This date may be transmitted when proximity is sensed, but optionally also when interrogated by the remote terminal.

The remote terminal may for example comprise a smart phone. The information may be as simple as a yes/no indication (for example a red light or a green light), but actual pollution levels or other quality information (temperature, humidity, CO2 levels etc.) can be provided to the remote terminal. The remote terminal may itself be controlled by the output, for example providing the indication to the user on their phone.

The processor may be adapted to transmit data to the remote terminal in dependence on the distance to the remote terminal.

For example, when the user is far from the window or door, they may simply be requesting the detailed air information, whereas when they are near they may simply want the justification for why they should or should not open or close the window or door.

The processor may be adapted to transmit data to the remote terminal which takes account of one or more of:

the weather or air quality forecast;

the geometry of all of the windows and doors coupling the second area to the first area.

The forecasts can enable the device to predict the times when the window or door should be opened. By taking account of the geometry, the system can indicate which windows or doors should be opened and when. This can take account of the direct sun or shade, depending on the time of day and the orientation of the windows and doors as well as the building design (for example with overhanging roofs, or verandas). It can also take account of wind direction and speed. This information can all be used to provide advice which enables the indoor climate to be controlled more effectively.

The output device controlled by the output from the system may comprise a visual and sound output device, wherein the processor is adapted to control the output device to generate a visual output only for providing advisory information, and to control the display and sound output device to provide a visual and audible output for providing warning information. This output device may then form part of the system, for example placed near the window or door from which proximity is being sensed,

There may in this way be two levels of information - general information and a warning. The visual and audible warning may override the need for proximity sensing.

The system may further comprise an indoor air treatment device, wherein the processor is further adapted to control the indoor air treatment device.

The same air quality sensors, temperature sensors or humidity sensors can be used to control air treatment as well as providing advisory information concerning doors or windows. Furthermore, the doors or windows may also have automated control so that they can also be controlled by the system, for example to maintain a desired atmosphere while a user is absent.

A closure sensor may be used for determining if the door or window is open or closed, wherein the closure sensor information is provided to the processor.

This enables the system to know about all windows and doors of a building and to provide advice as to when an open window or door should be closed or a closed window or door should be opened.

The processor may be adapted to provide an indication of the sensor capabilities required by the system in dependence on one or more of:

the location at which the system is to be used;

user input relating to the expected pollutants in the first or second areas; sensor information received from nearby air quality sensors not forming part of the system.

Multiple sensors may be required to provide monitoring of the air quality, for example chemical sensors and particle sensors for particles of different sizes. Some environments may not need all the different sensors, so this approach enables a basic sensor to be used. The system can then determine which other sensors are needed, for example based on other systems in the same area or user input. It also enables the data from nearby sensors to be shared between a network of systems so that unnecessary duplication can be avoided.

An aspect of the invention also provides an air quality alert method, comprising:

receiving a first air quality indication in respect of a first area;

operating a proximity sensing arrangement for detecting that a user is in the proximity of a door or window between the first area and a second area; and

processing the first air quality indication and a signal from the proximity sensing arrangement, and providing a recommendation for a status of the door or window.

The method may also comprise receiving a second air quality indication in respect of a second area and providing an output based on a difference between the first and second air quality indications. The method may in addition comprise wirelessly transmitting data to a remote terminal, wherein the data transmitted to the remote terminal is selected in dependence on the distance to the remote terminal.

### BRIEF DESCRIPTION OF THE DRAWINGS

Examples of the invention will now be described in detail with reference to the accompanying drawings, in which:

FIG. 1 shows a first example of alert system in accordance with the invention;

FIG. 2 shows a second example of alert system in accordance with the invention;

FIG. 3 shows a door handle which can incorporate touch sensing;

FIG. 4a shows an example of possible display output;

FIG. 4b shows another example of possible display output;

FIG. 5 shows an example of method of the invention;

FIG. 6 shows a third and fourth examples of alert system in accordance with the invention; and

FIG. 7 shows how systems can share sensor data.

### DETAILED DESCRIPTION OF THE EMBODIMENTS

The invention provides an air quality alert system which provides a signal which indicates whether or not a door or window should be (partially or fully) opened or closed. The system takes account of the air quality in a first area (e.g. outdoors) as well as the proximity of the user to a door or window so that information is only provided when the user is situated at the door or window. This avoids overloading the user with unwanted information.

Thus, the alert can be based on the user's presence and distance to the window or door. It can be based on the air quality outside, or on difference between outside and inside air quality. In this case, instead of outputting an indication of absolute air quality (e.g. pollution level), an output can be provided which is representative of the relative air quality, i.e. the difference between indoor and outdoor air quality, making it easier for user to decide when it is a good moment to open or close the window.

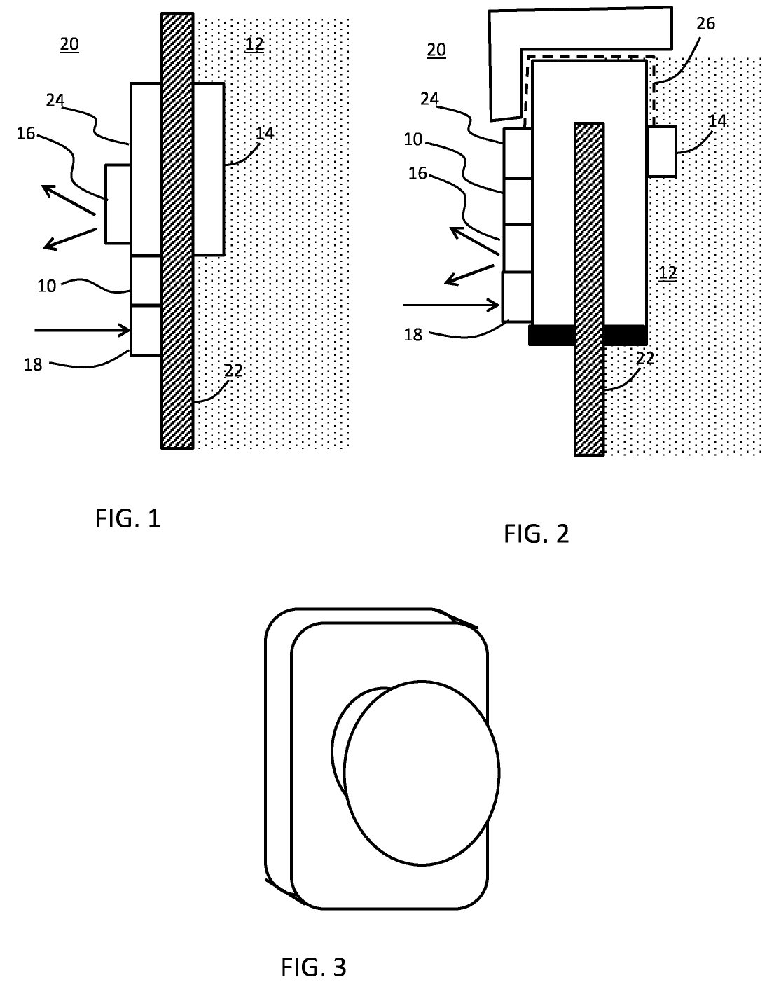

FIG. 1 shows a first example of an air quality alert system. The system has a processor 10. The processor has an input for receiving an indication of outdoor air quality for an outdoor area 12. It may receive this information from a remote source, but the example in FIG. 1 shows an outdoor air quality sensor 14 as part of the system.

The system has an output device 16 for example a display panel and/or an audio output device. A proximity sensor 18 is provided for determining that a user is in the proximity of a door or window between an indoor area 20 and the outdoor area. FIG. 1 shows the system mounted on a window 22.

The processor processes signals from the proximity sensor and the outdoor air quality indication, to control the output device 16 to provide an output signal which indicates whether or not the door or window should be opened or closed.

In the example of FIG. 1, the processor also has an input for receiving an indication of indoor air quality. Again, this may be received from a source external to the system itself but FIG. 1 shows the system with an indoor air quality sensor 24.

The air quality indication may comprise particulate matter concentrations for different particle sizes and or measurement of the concentration of volatile organic compounds (VOCs).

This system is able to provide advice to a user about whether or not to open a door or window, for example depending on either the absolute air quality outside, or the relative air quality outside compared to the prevailing air quality inside. By using a proximity sensor 18, the user can only be provided with the required information when it is needed, namely when the user is contemplating opening the door or window to improve ventilation. In this way, the user is not annoyed with unnecessary information, and the system can save power. The use of a proximity sensor means that the user does not need to specifically activate the system in order to be presented with the required advisory information.

FIG. 1 shows the system mounted on opposite sides of a pane of glass of a door or window. FIG. 2 shows the system mounted at a window frame. When mounted on a pane of glass, the communication of sensor information from the outside to the inside can for example be by an optical signal such as an LED-sensor pair, using a coded light signal between the indoor and outdoor parts. Other communication means such as near filed communications may of course also be used.

When mounted in a window frame, a wired connection can be provided around the glass beading, as shown by connection 26 in FIG. 2.

The components on opposite sides of the window pane may be mounted by gluing, or by magnetic coupling between them. The use of magnets may not be desirable in some cases (e.g. where theft is likely) but they add freedom of placement as the system is then easy to position and reposition on the window.

The system may instead be wall mounted adjacent the door or window, with a hole through the wall to feed electrical wires to enable the two sides to communicate.

The output device provides a visual or audio cue to inform the user on whether it is safe to open the window or door. In more advanced systems that may be integrated with the window structure, haptic feedback may be provided via the door or window handle. A window may be provided with an on-window display, such as a semi-transparent e-ink display.

The proximity sensing may be remote for example based on motion sensing or it may be based on touch, for example the user touching the door or window handle.

FIG. 3 shows a door knob, which may be provided with touch sensing to function as the proximity detection.

Alternatively, the proximity sensing may be based on a distance beacon or RF communication with a user for example using a smart phone device. An example of a suitable technology is the indoor proximity sensing system “iBeacon” of Apple Inc. (Trade mark). The technology may determine who is approaching the window so that it can for example ignore children, or give feedback which is personalized to the person approaching the window.

In cases where there is communication to a device carried by the user, such as a smart phone, that device may itself function as the output device. It is only activated when the user is at close proximity to the door or window, so that again the user is not annoyed with unwanted information.

The output device may comprise a display. In a most simple implementation, the display can simply give a green signal to indicate that it is safe to open the window or door and a red signal to indicate that it is not.

The system only alerts the user just before or during the action of opening the window or door. This just-in-time delivery of information may be ensured by mounting the system close to the handle of the window or door, and by integration of the proximity sensor. The proximity sensor may be a touch sensor mounted on the handle of the window or door, and connected to the alert system.

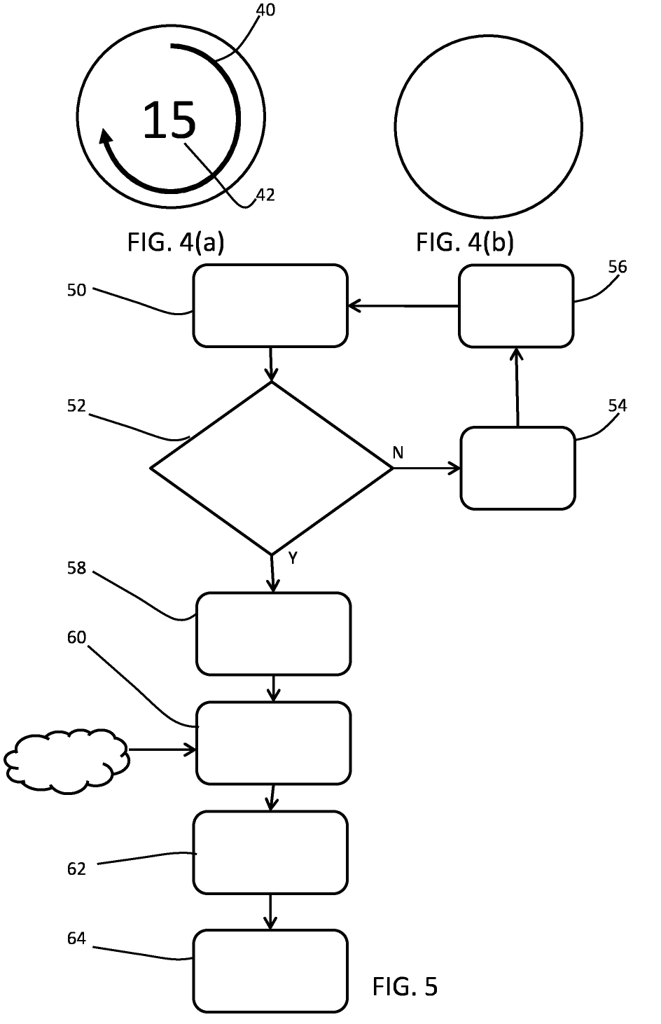

FIG. 4(a) shows a more elaborate output, in which a visual image 40 represents the air quality or relative air quality, and a numerical indicator 42 is also provided. This can provide numerical information about the air quality, or it may give a time for which the window should be opened (e.g. 15 minutes). As discussed further below, by using information from a distributed sensor network it becomes possible to estimate for how long it is safe to keep a window open based on current pollution levels and dynamic changes (e.g. wind direction, time of the day, etc.). For example, the output device can indicate if it is safe (e.g. with a green signal) as well as displaying a number of minutes during which it is safe to keep the window open.

This output is provided when the user is in close proximity, otherwise no output is provided as shown in FIG. 4(b). Alternatively, an outdoor air quality indication can be provided when the user is not in close proximity, whereas advice about whether or not to open the window is provided when the user is in close proximity.

The system, or at least the outdoor sensor part of the system, may be powered by solar cells.

FIG. 5 shows one example of operating method.

In step 50 a distance measurement is obtained from the proximity sensor. As mentioned above, this may a simple yes/no indication as to whether the user is touching the door or window handle, or it may be determination of an actual distance to the user.

In step 52 it is determined if the user is nearby. If not, the outdoor air quality is measured (or received from an external source) in step 54 and the outdoor air quality is displayed in step 56.

If the user is nearby, indoor air quality is measured or otherwise obtained in step 58. In step 60, optionally other information is taken into account, such as:

the outdoor weather conditions, for example it may be too windy to open the window;

the outdoor noise level, for example it may be too noisy to open the window;

the outdoor light level, for example when dark outside too many insects may be attracted inside;

the status of other windows or doors leading to the indoor area, for example there may be enough other open windows and doors or a through draft may want to be prevented;

air quality sensor signals from other outdoor air quality sensors provided at the building at which the system is mounted, for example to enable sharing of local outdoor sensor information;

air quality sensor signals from other outdoor air quality sensors not provided at the building at which the system is mounted, for example to enable a prediction over time of how the air quality is evolving over time and location;

air quality sensor signals from other indoor air quality sensors provided at the building at which the system is mounted, for example to enable sharing of indoor sensor information;

publicly broadcast air quality warning information, for example to gain knowledge of high pollen counts or chemical leakages or other hazards. In some countries, where there are frequent forest fires or when people live near chemical plants there are times when the authorities require people to close their windows for their own safety. By providing these warnings on the internet they could be communicated automatically using the alert system;

status information from climate control devices, such as an extraction hood, fan or air purifier.

This information can be obtained using wireless communication for example to a web-based application which gathers and collates the relevant information.

In step 62, the relative air quality is calculated.

In step 64, the indication is provided which advises whether or not the window or door should be opened. This is based on the relative air quality but also taking into account the optional additional information received in step 60.

The indication can include the amount of time for which it is believed to be appropriate to keep the window or door open, and information received in step 60 from a website can be used for this purpose, which already has gathered outdoor air quality data from various sources enabling dynamic changes to be estimated.

The advice may be to open or close the window. If the window is closed, the aim is to advise if it is safe to open the window and optionally for how long. This may because the inside air has become polluted due to cooking fumes for example. If the window is open, the aim is to advise if it should be closed because polluted air is entering the home.

As mentioned above, the system may include sensors or it may rely on other sensors.

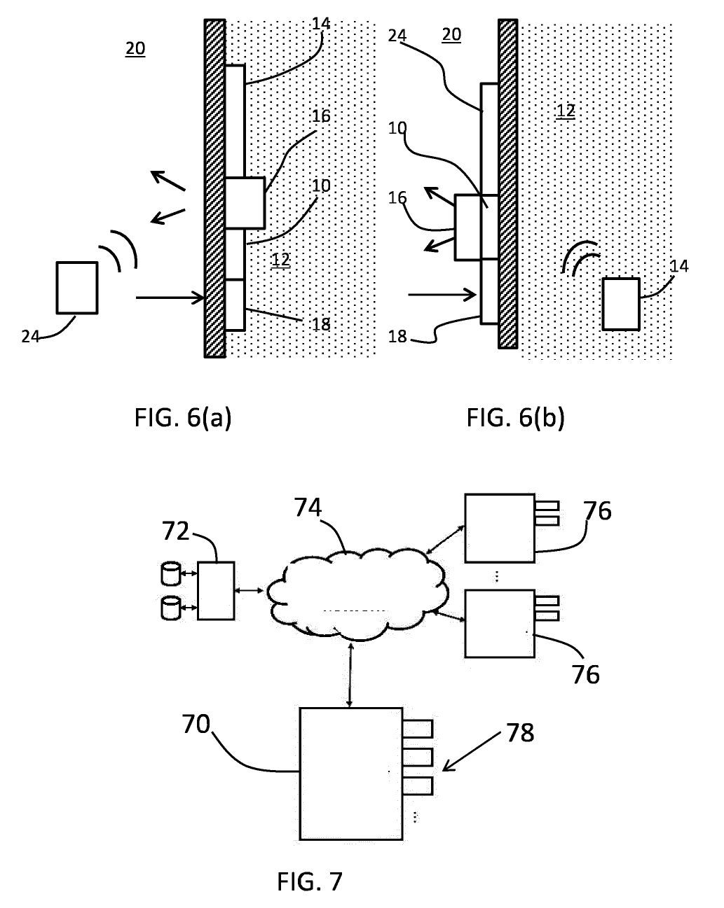

FIG. 6(a) shows an embodiment which is mounted outside, with display 16 which illuminates through the window and a proximity sensor 18 which receives signals through the window. The outdoor sensor 14 and processor may receive power from a power unit (i.e. battery, solar cell, not shown) mounted outside. The processor 10 is wirelessly linked to an indoor sensor 24.

FIG. 6(b), the system is mounted indoors. The system is the same as FIG. 1 but the outdoor sensor 14 is remote and is wirelessly linked to the indoor sensor and processor.

Another embodiment of the window alert system could not have any integrated sensors and could only contain an output device, processor, power unit and data connection to separate sensors: the indoor sensors are somewhere else in the room and an outdoor sensor is somewhere else on the balcony, roof, other building or based on website collection of data.

The system may further include magnetic contact sensors used to detect whether doors or windows are open or closed. The air quality alert system can then be combined with these magnetic contact elements on door posts or door frames so that the information provided can take account of whether window or door is currently open or closed. Thus, the information can be used to instruct opening or closing of the door or window as appropriate.

For example the system may detect that the window is open and the pollution level outside is increasing (or the window is closed but the pollution is decreasing) so that an alert could be given to remind users that they may need to close (or open) the window, for example by giving an audio cue. The user could for example read out current window alert status anywhere via a smart phone application.

The output device 16 may additionally inform the user about other information, for example as gathered in step 60 of FIG. 5, such as a difference between other indoor and outdoor environmental parameters, such as temperature, humidity, precipitation, wind level, light level or noise level. It may also be used to remind the home owner about which windows are open or closed as well as providing feedback on pollutants.

An automatic motorized window opener may be used so that the system can itself open or close the window based on the cleanness of the air inside and outside. For example, the system might open the window when air outside has reached a certain level of cleanness even if the user is not present, similarly instead of setting a timer for informing a user when to close, the system can close the window itself when the pollution level outside is raised beyond certain pre-set threshold.

The system may provide different output information depending on how close the user is standing to the window or door. For example, when the distance is large no information is displayed or just general information about the outdoor air quality. When the door or window is approached with the intention to open the door or window the alert can then indicate the relative difference between indoor and outdoor air quality allowing the user to decide if it is a good moment to open the window. When the user approaches the door or window, more precise measurements may be obtained to reduce energy consumption when not in use.

When a system makes use of a smart phone, it may be interrogated by the smart phone at any time, effectively overriding the proximity sensing. The information provided to the smart phone may also depend on the distance from the proximity sensor. The system may receive information about the direction in which the smart phone is pointing when making the interrogation and select the information to be provided to the depending on this. For example, the user may point the smart phone at a sensor to obtain detailed sensor information, whereas pointing in other directions may give more general advice about whether or not to open/close the door or window.

The system may be adapted to be used with so-called smart glasses, so that information is provided only when the user looks at the window. The output signal can be provided by the glasses themselves or by a display or audio device mounted at the door or window.

The system may provide recommendations for patterns of use. For example, based on the day's weather and pollution forecast, advice can be given about which window in the house to open and when. For example, it may be advisable to open the bedroom window on the north side in the mornings, the bathroom window on the south side in the evening. Extra elements that could be taken into account when making these recommendations are:

The geometry of the house. For example a house with windows under a roof with a lot of overhang are particularly suitable for opening for fresh air when rain is expected;

Vegetation information relating to the surroundings in combination with a profile of the user. For example, if a user is are allergic to beech pollen and the north side neighbor has a beech tree, it is beech season and the wind is from the north then do not open window on north side but choose another window. The control algorithm can weight the different parameters: for example pollen is more important than pollution. The weighting of parameters can depend upon people's profile, for example severe hay fever implies pollen is more important than fine dust.

The system can (when it has window sensors) provide a signal which advises to keep window closed, but this may only be provided when the suggested action is different to what would be expected by just looking outside the window (and seeing a clear sky). A camera can be used to analyze the sky colour for this purpose.

As mentioned above, there may be different alert signals, for example visual and audiovisual. For behavioral coaching, the audio feedback may be added only when the proposed action is different from what could be expected. This audio feedback can be used to attract the attention of the user even when he/she is further away from the window.

As explained above, the system can make use of integrated sensors or the collection of sensor data from other sensors. However, different types of sensor are needed depending on the particular pollutants that may be experienced. Such sensors are also used by air purifiers, which aim to reduce particles (e.g. PM10, PM2.5) and some chemical substances (CO, SO₂).

Another aspect of the invention thus relates to the provision of different sensors, for use in the alert system described above, but also (additionally or alternatively) for use in air treatment systems generally.

In accordance with this aspect, there is provided an air treatment system comprising:

a set of sensors;

an air treatment device; and

a processor adapted to provide an indication of the sensor capabilities required by the system in dependence on one or more of:

the location at which the system is to be used;

a user input relating to expected indoor or outdoor pollutants;

sensor information received from nearby air quality sensors not forming part of the system.

For a given room for which the air is to be cleaned, some pollutants typically enter the room through ventilation with outdoor air, while other pollutants typically originate from an indoor pollution source, such as formaldehyde evaporated from walls or furniture. For ease of reference, these pollutants can be considered to be outdoor and indoor pollutants, respectively.

To guarantee an indoor air quality for which the concentration of all possible pollutants is sufficiently small, an air purifier should have a sensor for each of them, as sensors for chemical substances are rather specific for a given substance. However, sensors can be quite costly.

An air purifier typically has one or a few number of sensors, and the same applies to the sensors for use in the window or door alert system described above. As such, high concentrations of some pollutants may remain unnoticed. Alternatively, an air purifier that is going to operate in a given region may not require a sensor for a given pollutant if this pollutant is (typically or almost surely) not present in this region.

This aspect is based on the idea of providing a system (an air purifier or door or window alert system) that enables easy addition of separate sensors. In this way, a user can first buy a system having a basic set of sensors. This basic set may simply be a single PM10 particle sensor. Depending on what the user assumes to be relevant for his or her situation, this basic set can be extended with specific additional sensors.

The processor of the system can then give advice on which sensors are most relevant, based on the outdoor pollutants that are relevant for the location at which the system is expected to operate. Additionally, the system may ask the user for additional information to establish the risk of indoor pollutants, such as whether or not people smoke in the given room, whether there is a fireplace, whether candles often burn, whether the room is newly constructed, what type of furniture they have, etc.

Additionally, the sensor data for outdoor pollutants can be shared by systems (air purifiers or door or window alert systems) that other users in the neighborhood are using. This sharing of sensor data is also outlined above. If a neighbor has a sensor for a specific pollutant, then a user does not need to buy a sensor for that pollutant, but instead can buy a sensor for another relevant pollutant, and obtain the pollution data from the neighbor's sensor via, e.g. the internet.

Assuming that information is maintained on which sensors are being used by each of the systems and assuming that their locations are known, the system could take this information into account in the advice on which sensors to acquire for outdoor pollutants.

This could be a service offered by the vendor of the system. By comparing a sensor's pollution data with data from other, corresponding sensors, it might also be possible to establish an approximate location.

To collect the external information, the system has an internet connection with a server that stores the sensor data. Via the server, the system can download estimated concentrations of pollutants for which the given system does not have a sensor, provided that another system having a sensor for the given pollutant is located sufficiently close to the given system.

Such information may also be shared between different types of system, namely some air purifier systems and some door or window alert systems.

In the case of an air purifier, and in the same way as the for the alert system, the sensors can be attached to the air purifier in a specific sensing compartment, or they can be located at another location in the room, or if desired, as an outdoor sensor. The air purifier will then be aware of the fact the sensor is positioned outside the room, and as such may not be directly influenced by the working of the air purifier.

This approach means that duplicated and unnecessary sensing is carried out. Users may only acquire sensors that are relevant to their own situation, taking into account sensors that are already available in the neighborhood. As such energy can be saved and users will be able to acquire sensors that are relevant to their own situation.

FIG. 7 shows an example of application of this approach to an air purifier 70. The air purifier 70 repeatedly shares information with a server 72 over an internet connection 74. The server 72 gathers air quality data from the air purifier 70, as well as other air purifiers 76 as well as from other sources such as the door and window alert system described above. The sensor information can be shared with other neighboring air purifiers. The server also incorporates the system that suggests the most appropriate other sensors that could be added.

The system then recommends the appropriate sensors for extending the existing set of sensors 78, depending on which sensors are (abundantly) available in neighboring systems as well as on what are relevant pollutants for the user. Sensors intended for outdoor measurement could be purchased by a community of people, for example by the inhabitants of an apartment building.

When opening doors or windows (as advised by the door or window alert system described above), the effectiveness of appliances such as air purifiers or air conditioners is negatively impacted. Solutions are available on the market that allow for automatic switch-off of air treatment appliances when the windows are detected to be open. Thus, there are known indoor air treatment systems which switch off automatically when windows are detected to be open and switch back on if the windows are closed.

Another aspect of the invention provides more advanced operation modes for indoor air treatment appliances that make use of this natural habit of opening the windows to refresh indoor air by exchanging it with outdoor air.

By using the open state of windows (closed, fully open, partially open, etc.) and environmental conditions outside (such as wind speed and direction, rain, pollution levels, sound etc.), air treatment devices (such as air purifiers, humidifiers, extraction hoods and air circulation devices such as fans and ventilation units) can be controlled more intelligently.

This aspect can operate by:

Sensing the state of the window or door (either open/closed, or partially opened) as well as its location relative to the sides of the building (e.g. north side of the building). The window sensing can of course make use of the window alert system described above;

Sensing the outdoor conditions either using local sensors or using online access to weather information (e.g. direction and strength of wind). This can again comprise the same source of information as used in some implementations of the window or door alert system described above;

Sensing the indoor condition (e.g. air flow, air cleanness). This can again comprise the same source of information as used in some implementations of the window or door alert system described above;

Sensing the presence of people or animals and optionally who they are e.g. children, adults, pets, plus their movement within the home to determine the most important rooms to clean etc. As patterns change so can the air cleaning patterns. If no user is present and the outdoor air quality is good, the system can open trickle vents and run a filter regeneration program;

Sensing the activity of people and anticipate bad air condition that needs window ventilation (e.g. cooking, smoking, working out);

Sensing the use of cleaning products and using this to adjust the air cleaning needs, e.g., chemical surface cleaning sprays may require a room to be ventilated or the frequency of use of the vacuum cleaner or sweeper may require the system to operate more or less frequently. Note that for detection of the use of a chemical spray, the handle of the spray may have a small Zigbee transmitter to sense when it is being used—the strength of the signal may determine which room it is in and for how long.

The behavior of the air cleaning and air circulation appliances can be adjusted based on what is sensed. Examples include controlling an air ventilator based on the sensed wind level, i.e. if wind creates enough air flow to switch off an air ventilator, and if not to maintain the required air flow using ventilator; automatically running a filter cleaning operation for an air purifier when the windows are open and air pollution level is below a preset threshold, etc.

Based on these measures, a holistic system is able to provide additional feedback on how to improve the air quality further based on the data input, e.g. vacuum more or less often, or indicate which particle types are being sensed most frequently for example from a pet, or pollen from a house plant etc.

A first embodiment of this aspect relates to the use of an air ventilator with an open window, by providing a link to the actual wind level.

Air ventilators are often used in combination with open windows, to enhance air circulation. This only makes sense when there is no or little wind outside. When there is wind above a certain threshold outside and the window is open, indoor air circulation is already good enough and operating the ventilator can only be seen as waste of energy. In the case of open windows, the air ventilator settings can be linked to the outdoor wind level obtained from an outdoor wind sensor, or from a pressure sensor capable of measuring the pressure difference between indoors and outdoors or from third party data.

Only when the wind level is below a certain threshold, the air ventilator is switched on. Based on the wind level it is also possible to fine tune how much air flow the ventilator needs to create, thus optimizing power consumption. When the wind level exceeds the threshold, the ventilator is automatically switched off.

In addition to linking the ventilator settings to the outdoor wind level, they can also be programmed to depend on the level of the indoor air flow. Thus, when windows in two opposite rooms are open as well as the connecting door between the rooms, natural air flow in the rooms might already be sufficient and the ventilator can be switched off as well.

A second embodiment of this aspect relates to the use of an air purifier with an open window, by controlling a filter regeneration mode.

Indoor air cleaning using an air purifier is only effective when the windows in that room are closed. When the windows in the room of the air purifier are open, normally the purifier can be switched off. This can be automated by linking the information from the window status sensors in that room to the air purifier in the same room.

There is however an operation mode in which it is useful to operate the air purifier when the windows are open. That is, when the filters can be regenerated, it is good to pass air through the air cleaner when the window is open. This regeneration applies particularly to activated carbon filters for adsorbing VOCs from air, and to chemical absorption filters for absorbing gases such as formaldehyde, NH₃, HNO₂, and SO₂ from air. These adsorbed/absorbed gases slowly desorb from their filters when reasonably “clean” air is passed through these filters. The desorbed gases are thereby taken away with the ventilation airflow not only from the filters but also from the room to outdoors. In this regard, “clean” means that the outdoor air comprises concentrations of the respective gases that are below certain threshold concentration levels below which the air is considered to be safe for human health and well-being.

If the outdoor air comprises gases at concentrations above their respective safe threshold concentration levels, the outdoor air is too polluted to be used for filter regeneration and the air cleaner should remain switched off.

By linking information on the filter status (e.g. from an embedded sensor or timer) to the status of window and outdoor air pollution levels of various gaseous pollutants, this auto-regeneration mode can be triggered if appropriate and useful. This regeneration can be made more effective when outdoor wind level is also taken into account, since a larger wind means larger air flow and therefore faster regeneration.

Optionally, a filter regeneration program is activated both based on user presence sensing and sensing of outdoor air quality. When the user is not present and the outdoor air quality is good, the system can open trickle vents and run the filter regeneration program. Using predictive algorithms on user presence (i.e. the system can predict when the user comes home) the air purifiers can run at high power just before the user comes home to filter away any particles which may remain in the air as a result of the filter regeneration program, as a kind of post-regeneration cycle.

A third embodiment of this aspect relates to the use of robot air treatment appliances which are linked to the window opening status.

People often have only one or a few air treatment appliances at home (for example one air purifier, one air ventilator, one air conditioner). When these appliances are mobile, they take them from one room to the other, where they regard them to be needed the most.

Robot air treatment appliances (like a robot vacuum cleaner) can be used which roam between rooms of a house or apartment. They can then determine a preferred location for air treatment in the house based on the status of the windows in the various rooms of the house or apartment, in combination with the weather/wind information. In this way the appliance will be able to automatically treat or clean air only where most effective. Moreover if the filter needs cleaning the air purifier can also move itself to the room with an open window to perform this operation.

A fourth embodiment of this aspect relates to the calibration of indoor air quality using an outdoor air quality indication.

As explained above, the system makes use of a proximity sensing arrangement. This can detect presence of a person within a certain distance, or detect immediate presence based on touch, and it may additionally provide range information. Some examples above make use of range information to control the information provided to the user. Some examples of possible technology for the proximity sensing or range determination are listed below. Some different technologies may also be used in combination. The examples are:

A proximity sensor such as a passive infrared sensor, active infrared sensor, thermal sensor, sonar sensor, capacitive sensor;

A camera, possibly linked to face recognition software;

A microphone, detecting sound or voice, possibly linked to speech recognition software;

An accelerometer, to detect the window being opened (and therefore the presence of the user)

A touch sensor in window handle, for instance a capacitive sensor;

An Air flow sensor for detecting air flow from a person approaching, and also distinguishing between window being open and closed;

A pressure sensor in a mat underneath the window or door;

A floor motion sensor, such as an accelerometer on the floor or a microphone on floor;

An electronic beacon in window area which communicates with a wearable device (smartphone, watch, glasses) in proximity;

A user wearing an RFID tag detected by the RFID sensor at the window;

A user wearing a Bluetooth low energy proximity tag detected by a sensor at the window.

A user wearing smart glasses detected by a sensor at the window;

A user wearing smart glasses with a camera recognizing the window;

A user wearing a smartphone or tag which enables their indoor location to be tracked, which can then be linked to a building model to determine window proximity.

When windows are opened for certain period of time and an equilibrium is reached between the indoor and outdoor air quality, air quality sensors mounted indoors can be calibrated using data from the outdoor air quality sensors. This outdoor air quality data can be obtained from air quality sensors mounted at or near the actual house in question, or from sensors mounted elsewhere in the street, suburb or city.

The invention is of particular interest for use in areas with high pollution level, in homes and other indoor areas. The alert system may be used in the home but also in the workplace or even in motor vehicles.

As discussed above, the invention makes use of a processor. The processor can be implemented in numerous ways, with software and/or hardware, to perform the various functions required. A microprocessor is one example of a controller that may be programmed using software (e.g., microcode) to perform the required functions. A controller may however be implemented with or without employing a microprocessor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform at the required functions. Various storage media may be fixed within a processor or controller or may be transportable, such that the one or more programs stored thereon can be loaded into a processor or controller.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. Any reference signs in the claims should not be construed as limiting the scope.

1. A system, comprising:
an input for receiving a first air quality indication for a first area;
a proximity sensing arrangement for determining if a user is in the proximity of a door or window between the first area and a second area;
an output for providing a recommendation for a status of the door or window; and
a processor,
wherein the processor is adapted to process the first air quality indication and a signal from the proximity sensing arrangement, and to control the output accordingly;
wherein, the system further comprising an input for receiving an indication of a second air quality for the second area, and
wherein the processor is adapted to control the output based on a difference between the first air quality indication and the second air quality indication.

2. A system as claimed in claim 1, wherein the system comprises a first air quality sensor for measuring and providing the first air quality indication, and a second air quality sensor for measuring and providing the second air quality indication.

3. (canceled)

4. A system as claimed in claim 1, wherein the system further comprises an input for receiving at least one of the following parameters:
the weather conditions;
the noise level;
the light level;
the status of other windows or doors leading to the second area;
air quality indications from other air quality sensors relating to the first area provided at the building at which the system is mounted;
air quality indications from other air quality sensors relating to the first area and not provided at the building at which the system is mounted;
air quality indications from indoor air quality sensors provided at the building at which the system is mounted;
publicly broadcast air quality warning information;
status information from climate control devices.

5. A system as claimed in claim 1, comprising a wireless transmitter for wirelessly transmitting data to a remote terminal, wherein the transmitter is adapted to transmit data when proximity is sensed and/or when interrogated by the remote terminal.

6. A system as claimed in claim 5, wherein the processor is adapted to transmit data to the remote terminal in dependence on the distance to the remote terminal.

7. A system as claimed in claim 5 or wherein the processor is adapted to transmit data to the remote terminal which takes account of one or more of:
the weather or air quality forecast;
the geometry of all of the windows and doors coupling the second area to the first area.

8. A system as claimed in claim 7, wherein the processor is adapted to transmit data to the remote terminal which, by taking account of the geometry including the orientation of the windows and doors and the building design, and taking account of the time of day indicates which windows or doors should be opened and when.

9. A system as claimed in claim 1, wherein the output is provided to an output device which comprises a visual and sound output device, wherein the processor is adapted to control the output device to generate a visual output only for providing advisory information, and to control the display and sound output device to provide a visual and audible output for providing warning information.

10. A system as claimed in claim 1, further comprising an indoor air treatment device, wherein the processor is further adapted to control the indoor air treatment device.

11. A system as claimed in claim 1, wherein the processor is adapted to provide an indication of the sensor capabilities required by the system in dependence on one or more of:
the location at which the system is to be used;
user input relating to the expected pollutants in the first or second areas;
sensor information received from nearby air quality sensors not forming part of the system.

12. An air quality alert method, comprising:
receiving a first air quality indication in respect of a first area;
operating a proximity sensing arrangement for detecting that a user is in the proximity of a door or window between the first area and a second area;
receiving a second air quality indication in respect of the second area; and
processing the first air quality indication, the second air quality indication and a signal from the proximity sensing arrangement, and providing a recommendation for a status of the door or window based on the processing.

13. A method as claimed in claim 12, wherein the first area is outdoors and the second area is indoors, and the processing takes account of one or more of:
the outdoor weather conditions;
the outdoor noise level;
the outdoor light level;
the status of other windows or doors leading to the indoor area;
outdoor air quality indications from other outdoor air quality sensors provided at the building at which the system is mounted;
outdoor air quality indications from other outdoor air quality sensors not provided at the building at which the system is mounted;
indoor air quality indications from other indoor air quality sensors provided at the building at which the system is mounted;
publicly broadcast air quality warning information;
status information from climate control devices.

14. A method as claimed in claim 12, further comprising providing an indication of the sensor capabilities required by the system in dependence on one or more of:
the location at which the system is to be used;
user input relating to the expected pollutants in the first or second areas;
air quality indications received from nearby air quality sensors not forming part of the system.

15. A system as claimed in claim 1, further comprising a wireless data transfer system for wirelessly transmitting the output to a remote terminal.

16. A window opener, comprising:
a system according to claim 1;
a motor for opening or closing the window depending on the output.
